(19) United States
(12) Patent Application Publication
(10) Pub. No.: US 2017/0267215 A1
(43) Pub. Date: Sep. 21, 2017

(54) VEHICLE WINDSCREEN WIPER HEATING ELEMENT

(71) Applicant: Valeo Systèmes d'Essuyage, Le Mesnil Saint Denis (FR)

(72) Inventors: Gérald Caillot, Cernay La Ville (FR); Vincent Izabel, Chilly Mazarin (FR); Jean-Michel Jarasson, Le Mesnil Saint Denis (FR)

(73) Assignee: Valeo Systèmes d'Essuyage, Le Mesnil Saint Denis (FR)

(21) Appl. No.: 15/464,715

(22) Filed: Mar. 21, 2017

(30) Foreign Application Priority Data
Mar. 21, 2016 (FR) 1652404

(51) Int. Cl. B60S 1/38; B60S 1/48

(52) U.S. Cl. CPC B60S 1/3805; B60S 1/488

(57) ABSTRACT

Windscreen wiper heating element for a vehicle, in particular a motor vehicle, including an electrical heating conductor circuit (120) and a support (118) of that circuit, the circuit including at least one loop (122) the ends of which are connected to electrical power supply terminals (126, 128) characterized in that said at least one loop includes at least one fusible portion (F1, F2) in which the section and/or the material of the conductor of that loop is different from that or those of the conductor of the rest of the loop.

The present invention concerns a windscreen wiper heating element for a vehicle, in particular a motor vehicle, and a vehicle windscreen wiper including that element.

It is known to heat a motor vehicle windscreen wiper, in particular to de-ice it in winter. If the wiper includes internal channels for distribution of windscreen washer liquid, heating the wiper also makes it possible to heat the liquid before it is sprayed onto the windscreen of the vehicle, which facilitates de-icing the windscreen and can therefore avoid the use of a manual ice scraper.

A windscreen wiper of the “flat wiper” type typically includes a longitudinal body carrying a blade, generally made of rubber, intended to rub against the windscreen of the vehicle to evacuate water out of the field of view of the driver. The wiper further includes at least one longitudinal spine that imparts a curvature to the blade, so as to favour the application of the blade to the windscreen. The wiper is carried by an arm that is driven by a motor in an angular to-and-fro motion. The means connecting the wiper to the arm generally include a collector that is fastened to the body and an adapter that is articulated to the body and fixed to one end of the arm.

In the current state of the art, the means for heating a windscreen wiper generally include a heating electrical conductor.

It has already been proposed to equip the spine of a wiper with heating means taking the form of a film that is applied to and stuck onto the spine and that includes a heating electrical conductor circuit or track. In the current state of the art, the conductor of the circuit forms a loop the ends of which are connected to electrical power supply terminals.

For a top of the range vehicle, the windscreen wiper heating function is generally controlled and protected directly by the electronics and the electrical circuit of the vehicle. This necessitates specific integration on the upstream side of designing the electrical architecture of the vehicle and therefore generates a certain cost.

For mid-range or lower grade vehicles, some clients do not wish to modify their architecture and require direct integration of the protection into the heating wiper so as not to affect the other functions of the vehicle in the degraded mode of the function (incorrect information, failure of the outside temperature sensor or vehicle speed sensor, for example).

The heating function is generally triggered below an outside temperature of +5° C. to ensure overall de-icing of the wiper, whether that means the distribution channels, the means for connecting the wiper to the arm, or even the blade in contact with the windscreen. In a degraded mode (for example if a vehicle outside temperature or speed sensor fails—for example the if vehicle is stopped but the sensor indicates that the vehicle is in motion), the effect would be permanent heating of the wipers beyond +5° C., potentially in summer with ambient temperatures exceeding +30° C., with a potential risk of leading to a hot spot, a short circuit, physical damage of the wiper and in the worst case scenario a fire.

The invention proposes a simple, effective and economical solution to this problem of the prior art.

The invention proposes a windscreen wiper heating element for a vehicle, in particular a motor vehicle, including an electrical heating conductor circuit and a support of that circuit, the circuit including at least one loop the ends of which are connected to electrical power supply terminals, characterized in that said at least one loop includes at least one fusible portion in which the section and/or the material of the conductor of that loop is different from that or those of the conductor of the rest of the loop.

With the aim of protecting the electrical and electronic circuit of the vehicle, preventing damage of the wiper and therefore of the wiping function, which are essential for the client, the invention proposes to integrate into the heating element of the wiper a fusible function making it possible to avoid the above risks. If the fusible function of the heating element is activated, the wiper loses its heating function, which remains optional, and retains its wiping function, which is a statutory requirement. This loss of function may be temporary or permanent.

The advantage of the solution is its compactness and ease of integration, compared to other thermal protection solutions, in particular reversible ones, for example using a bimetallic strip, etc., which may necessitate complex operations such as brazing, for example.

According to one embodiment of the invention, the fusible function is produced by modifying, and in particular reducing, the section of the conductor (such as a heating track). A restriction of the section of a conductor creates a fusible portion that is more sensitive to overheating and is intended to cede, which renders the heating function of the wiper inactive.

In a variant, the fusible function is produced by means of a material different from the rest of the loop, which is generally a metal or a metal alloy. The various embodiments and variants of the invention can naturally be combined.

The heating element according to the invention may have one or more of the following features, separately or in combination:

said at least one fusible portion has at least one transverse dimension, such as a width and/or a thickness, that is different from that or those of the conductor of the rest of the loop,

said at least one fusible portion is made of a material intended to melt if it is subjected to a predetermined temperature,

said at least one fusible portion is made of a material the resistance of which varies, and in particular increases, as a function of the temperature to which it is subjected; its resistance can increase as the temperature rises,

at least said rest of the loop is made of metal such as copper, copper-nickel alloy, brass (CuZn) or aluminium, etc.,

the support has an elongate shape and a substantially plane longitudinal surface, said terminals being situated on that surface and at a distance from the longitudinal ends of the support,

the terminals are situated in a substantially median zone of the support that extends over 30 to 70% of its length, for example, as measured from one of its longitudinal ends,

the heating element includes a first loop that extends from the terminals toward one of the longitudinal ends of the support and a second loop that extends from the terminals toward the opposite end of the support; alternatively, the could be only one loop,

at least one of the loops has the general shape of a U or a W,

at least one of the loops includes undulations, and

the support is a spine for imparting a curvature to the windscreen wiper.

The present invention also concerns a windscreen wiper for a vehicle, in particular a motor vehicle, including a heating element as described above. The heating element preferably forms a spine for imparting a curvature.

The wiper may include means of connection to a driving arm of the wiper. Those connecting means may include means of electrical connection to the terminals of the heating element circuit.

The invention will be better understood and other details, features and advantages of the invention will become apparent on reading the following description given by way of non-limiting example and with reference to the appended drawings, in which:

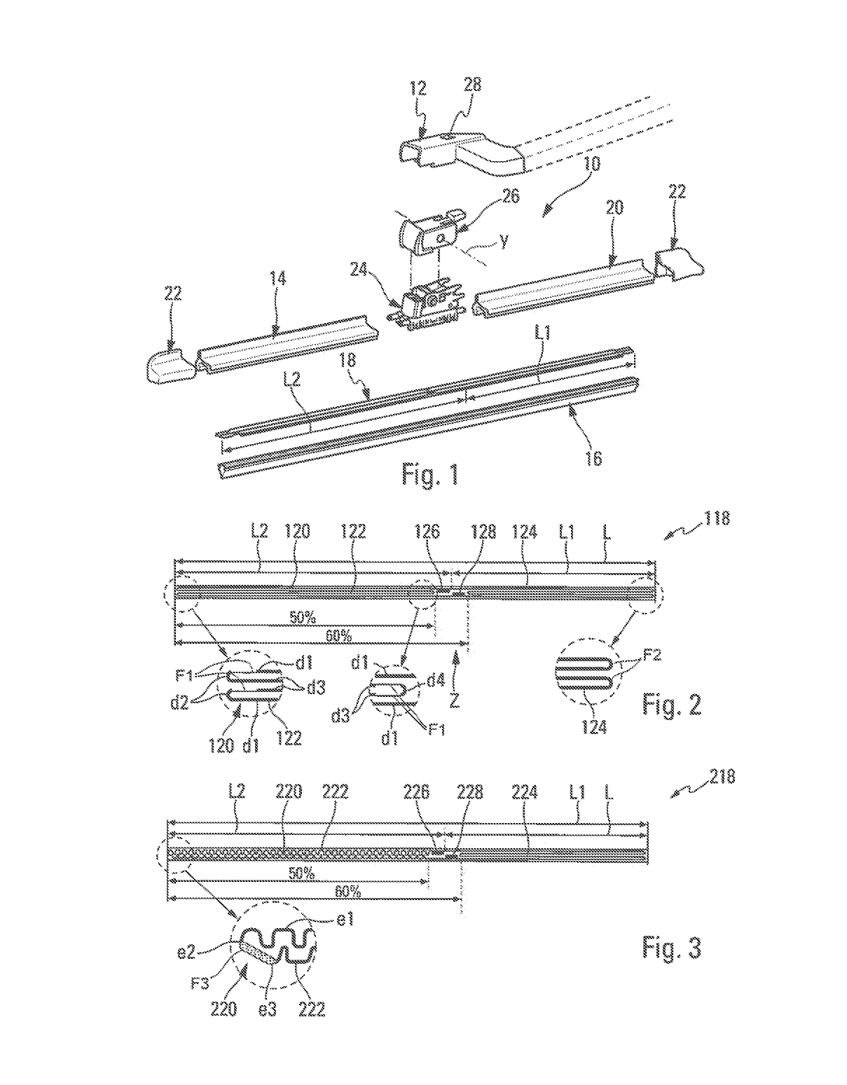

FIG. 1 is an exploded perspective view of a motor vehicle windscreen wiper,

FIG. 2 is a diagram showing a heating element according to the invention, and

FIG. 3 is a diagram showing a variant embodiment of a heating element according to the invention.

It should be noted that the figures show the invention in detail for the requirements of implementing the invention, said figures being of course usable to define the invention better if necessary.

In the following description, the terms longitudinal and lateral refer to the orientation of the windscreen wiper according to the invention. The longitudinal direction corresponds to the principal axis of the wiper along which it extends and the lateral orientations correspond to concurrent straight line segments, that is to say straight line segments that cross the longitudinal direction, notably perpendicularly to the longitudinal axis of the wiper in its plane of rotation. For the longitudinal directions, the terms top or bottom are referenced to the point at which the wiper is fixed to the wiper support arm, the term interior corresponding to the part in which the arm and one half-wiper extend.

FIG. 1 shows a motor vehicle windscreen wiper 10 and an arm 12 driving that wiper 10, that arm 12 being partially represented and intended to be driven by a motor so that the wiper performs an angular to-and-fro movement making it possible to evacuate water and possibly other undesirable elements covering the windscreen.

Here the wiper 10 includes a longitudinal body 14, a blade 16, generally made of rubber, and at least one spine 18 that imparts a curvature to the blade 16 so as to the improve the application of said blade to the windscreen.

The body 14 of the wiper 10 includes an upper spoiler 20 intended to improve the operation of the wiper, the purpose of this spoiler 20 being to increase the pressure of the wiper on the windscreen and therefore to improve the aerodynamic performance of the system.

The wiper 10 further includes end-pieces or clips 22 for attaching the blade 16 and the spine 18 to the body, these clips 22 being situated at each of the longitudinal ends of the body 14.

Here the body 14 of the wiper is produced in two independent parts that are disposed substantially end-to-end and connected to one another by an intermediate connector 24.

For mounting it on the arm 12, the wiper 10 includes an adapter 26 mounted on the connector 24 and allowing articulation of the wiper 10 relative to the arm 12. The articulation of the wiper 10 relative to the arm 12 is an articulation in accordance with a movement of rotation about a rotation axis Y perpendicular to the longitudinal axis of the wiper 10. In fact, to allow the wiper 10 to follow the curvature of the windscreen, the wiper 10 must have at least one degree of freedom in rotation relative to the arm 12 and to be more specific relative to an end part 28 of the arm 12.

The invention concerns in particular a windscreen wiper of the type including a heating element including a heating electrical conductor circuit or track and a support for that circuit.

According to one embodiment of the invention, the support is a spine of the windscreen wiper. A typical spine is made of metal and has an elongate shape. A spine generally has a section of substantially rectangular shape and comprises two substantially parallel plane surfaces at the top and bottom, respectively.

FIGS. 2 and 3 show two variant embodiments of the invention. Each of these figures shows a spine 118, 218 one of the aforementioned plane surfaces of which is covered by a heating electrical conductor circuit 120, 220.

The conductor is generally made of stainless steel or an alloy based on copper, nickel, aluminium, etc. (cupronickel, brass, etc.).

In the example shown, each circuit 120, 220 comprises two loops 122, 124 (FIG. 2), 222, 224 (FIG. 3) and two terminals 126, 128 (FIG. 2), 226, 228 (FIG. 3) for the supply of electrical power to these loops. To this end, the two ends of each loop 122, 124, 222, 224 are connected to the respective two terminals 126, 128, 226, 228. To be more precise, the positive terminal 126, 226 is connected to a first end of each loop 122, 124, 222, 224 and the negative terminal 128, 228 is connected to the opposite end of each loop.

Alternatively, each circuit may comprise a single loop. In this case, the positive terminal is connected to a loop that extends as far as one end of the heating circuit and then returns to the other end and to the negative terminal. In the aforementioned situation of a heating circuit with two parallel loops, there is a bottom loop and a top loop and each loop is connected to the positive terminal and the negative terminal.

As seen in FIGS. 2 and 3, the spine 118, 218 has a length L and the terminals 126, 128, 226, 228 are situated at a distance from the longitudinal ends of the spine and in its substantially median zone Z. Here these terminals are situated in a zone Z extending over approximately 50 to 60% of the length of the spine as measured from one longitudinal end thereof (and therefore approximately 40 to 50% as measured from the opposite end of the spine).

This zone Z may correspond to the position on the spine 118, 218 of the windscreen wiper connector. In fact, the connector may include electrical connection means intended to come into contact with the terminals 126, 128, 226, 228 of the circuit of the spine in the mounting position. Alternatively, the connector may be centred on the spine with the electrical connection between the terminals and the connecting means off-centre (for reasons of overall size, for example).

The loop 122, 222 extends over a first longitudinal part of length L1 of the spine 118, 228 between the terminals and the free end of that longitudinal part. The loop 124, 224 extends over the second longitudinal part of length L2 of the spine 118, 228 between the terminals and the free end of that longitudinal part.

Here the loops 122, 124 and 224 have a W-shape and include two straight lines d1 along and parallel to the respective longitudinal edges of the spine, these lines d1 having first ends that are connected to the respective terminals 126, 128, 226, 228, and opposite ends d2 that are bent and connected to respective first ends of two straight lines d3 extending between the aforementioned straight lines d1. The opposite ends d4 of the straight lines d3 are connected together and form what is substantially a U-shape.

Note in FIG. 3 that the loop 222 has a different shape and includes undulations. To be more precise, the loop 222 includes a first undulating line e1 along one longitudinal edge of the spine and one end of which is connected to the terminal 226, the opposite end e2 of this line e1 being bent and connected to a respective first end of another undulating line e3 along the other longitudinal edge of the spine and the opposite end of which is connected to the terminal 228.

Alternatively, the loops of the conductor could include a multitude of straight parallel lines connected to one another in series. Each loop could for example be of the WWW type, including a plurality of successive W-shaped parts.

The loops of the spine 118, 218 may be different and for example configured so that the powers dissipated in the two longitudinal parts of the spine are different.

At least one loop 122, 124, 222, 224 and preferably all of them include(s) at least one fusible portion F1, F2, F3 in which the section and/or the material of the conductor of the loop is different from that or those of the conductors of the rest of the loop.

In FIG. 2, each loop 122, 124 includes at least one fusible portion F1, F2 having a smaller cross section than the rest of that loop. The fusible portions F1 of the loop 122 each have a width (measured in the plane of the spine) less than that of the rest of the loop 122. The fusible portion F2 of the loop 124 has a thickness (not visible—measured in a plane perpendicular to that of the spine) that is less than that of the rest of the loop 124.

The heating effect of the heating element may be controlled by a pulse width modulation (PWM) electronic circuit connected to a temperature sensor of the vehicle or a sensor of the speed of the vehicle. Should a sensor produce erroneous information (vehicle apparently moving at 150 km/h when stopped, outside temperature below zero in summer, etc.), the PWM circuit could activate an inappropriate voltage (16 V instead of a lower voltage when the vehicle is stopped, for example), which would lead to a very great increase in temperature.

It is known that the resistance of an electrical conductor is given by the formula: R=ρ.L/S (in which ρis the resistivity, L the length and S the section), and that the power dissipated by the Joule effect is given by the formula P=R.1². This dissipated power can therefore be expressed by P=ρ.L/S.1². It is therefore clear that reducing the section of a conductor leads to an increase in the dissipated power. The reduced sections of the conductor in the fusible portion F1, F2 are determined so that this fusible portion breaks in the event of overheating of the wiper because of the application of the aforementioned voltage.

Here the fusible function is of the “electrical” type because the fuse is integrated directly into the heating element (resistive circuit). The aim is the melting of a local portion F1, F2 by the effect of the increase in temperature caused by an excess current. The electrical fusible function is irreversible because the fusible portion melts and therefore opens the circuit and cuts off the flow of current.

The function or functions F1, F2 may be situated at the longitudinal ends of the corresponding loop. The loop 122 includes a fusible function F1 at each of its longitudinal ends and therefore at the level of a free end of the spine 118 and at the level of the connecting terminals 126, 128. The loop 124 includes the fusible function F2 at a free end of the spine 118.

Alternatively, the fuses F1, F2 and F3 could be elsewhere than at the ends of the spine.

In FIG. 3, the loop 222 includes at least one fusible portion F3 the material of which is different from that of the rest of the loop.

According to one embodiment, this material is intended to melt if it is subjected to a predetermined temperature, such as in the event of overheating of the wiper. As in the aforementioned situation, the fuse F3 is irreversible in this case.

In the example shown, the loop 222 includes a fusible function F3 at a free end of the spine 218.

1. A windscreen wiper heating element for a motor vehicle, comprising:
an electrical heating conductor circuit; and
a support for the conductor circuit,
the conductor circuit comprising at least one loop the ends of which are connected to electrical power supply terminals,
wherein said at least one loop includes at least one fusible portion in which a material of the fusible portion of the conductor of the loop is different from that of the conductor of a remaining portion of the loop.

2. The heating element according to claim 1, wherein said at least one fusible portion has at least one transverse dimension selected from a group consisting of a transverse width and a transverse thickness, that is different from that of the conductor of the remaining portion of the loop.

3. The heating element according to claim 1, wherein said at least one fusible portion is made of a material intended to melt when the material is subjected to a predetermined temperature.

4. The heating element according to claim 1, wherein said at least one fusible portion is made of a material the resistance of which varies as a function of a temperature to which the material of the fusible portion is subjected.

5. The heating element according to claim 1, wherein at least said remaining portion of the loop is made of a metal selected from a group consisting of: copper, copper-nickel alloy, brass and aluminium.

6. The heating element according to claim 1, wherein the support has an elongate shape and a substantially plane longitudinal surface, said terminals being situated on the plane longitudinal surface and at a distance from longitudinal ends of the support.

7. The heating element according to claim 6, wherein the terminals are situated in a substantially median zone of the support that extends over 30 to 70% of a length of the support, as measured from one of the support's longitudinal ends.

8. The heating element according to claim 6, further comprising a first loop that extends from the terminals toward one of the longitudinal ends of the support and a second loop that extends from the terminals toward an opposite end of the support.

9. The heating element according to claim 8, wherein at least one of the loops has the general shape of a U or a W.

10. The heating element according to claim 8, wherein at least one of the loops includes undulations.

11. The heating element according to claim 1, wherein the support is a spine of the windscreen wiper.

12. A windscreen wiper for a motor vehicle, including a heating element according to claim 1.

13. The windscreen wiper according to claim 12, wherein the heating element forms a spine for imparting a curvature.

14. The windscreen wiper according to claim 12, further comprising means of connection to a driving arm of the wiper, said connecting means including means for electrical connection to the terminals of the circuit of the heating element.
